(19) United States
(12) Patent Application Publication
(10) Pub. No.: US 2026/0355853 A1
(43) Pub. Date: Nov. 12, 2026

(54) LASER PROCESSING SYSTEM WITH LIDAR SENSOR, AND METHOD FOR CARRYING OUT A LASER PROCESSING PROCESS USING SUCH A LASER PROCESSING SYSTEM

(71) Applicant: PRECITEC GMBH & CO. KG, Gaggenau (DE)

(72) Inventors: Jonas WEBER, Neuhausen (DE); Marcel SCHÄFER, Lichtenau (DE); Rüdiger MOSER, Malsch (DE); Igor SHKARBAN, Rheinstetten (DE); Tom WALDE, Offenburg (DE); Mathias BACH, Pfinztal (DE); Niklas WECKENMANN, Rastatt (DE); Ludwig WEBER, Gernsbach (DE); Christian LOOSE, Gaggenau (DE)

(21) Appl. No.: 19/122,571

(22) PCT Filed: Oct. 19, 2023
(86) PCT No.: PCT/EP2023/079104

§ 371 Date: Apr. 18, 2025

(30) Foreign Application Priority Data
Oct. 19, 2022 (DE) 10 2022 127 484.5

(51) Int. Cl. B23K 26/03

(52) U.S. Cl. CPC B23K 26/032

(57) ABSTRACT

A laser machining head includes: a housing in which at least one optics for directing the laser beam to a machining point on the workpiece is arranged; at least one frequency-modulated and/or amplitude-modulated continuous-wave lidar sensor for detecting a distance to at least one point on the workpiece, the lidar sensor having an emitter and a detector; and a control for monitoring and/or open-loop controlling and/or closed-loop controlling the machining process based on the detected distance. A corresponding method carries out a laser machining process.

### CROSS-REFERENCE TO RELATED APPLICATIONS

The present invention is the national phase entry of International Patent Application No. PCT/EP2023/079104, filed Oct. 19, 202, which claims priority to Denmark Patent Application No. 102022127484.5, filed Oct. 19, 2022, the entire contents of both are hereby incorporated by reference.

### FIELD OF THE INVENTION

The present disclosure relates to a laser machining system with a lidar sensor and to a method for performing, in particular for monitoring and/or open-loop controlling and/or closed-loop controlling, a laser machining process by means of a laser machining head with a lidar sensor.

### TECHNICAL BACKGROUND

Monitoring or performing a laser machining process, such as laser cutting or laser welding, is usually based on predefined parameter sets that are deemed to be good in the qualification of the respective process. Due to unforeseeable influence factors, such as material composition, process windows must be provided with certain buffers. Nevertheless, unforeseen parameters may cause process instabilities, resulting in scrap. Active closed-loop control may adjust process parameters and thus ensure greater stability in laser material machining. In addition, improvements in process control may lead to the use of optimized machining parameters, such as higher machining speeds or greater material thicknesses. Accordingly, the process can be operated with a narrower process window and the scope of applications can be expanded by means of process control.

In so-called remote laser material machining, the deflection of the machining beam is typically controlled by deflection optics. Scanning the machining beam makes it possible to achieve significantly higher process speeds than when moving the entire laser machining head, which is due to the significantly lower inertia of the deflection optics compared to the overall mechanism. The distance and the deflection optics make a machining range accessible in which even large components can be machining without further movement of the laser machining head. Remote laser material machining is also frequently used for machining more complex 3D components. Accordingly, a device and a method are required that can determine the topography and the exact distance between the component and the laser machining head. This, in turn, can be used for process control and process monitoring, in particular for setting process parameters before the start of or during the process. Furthermore, the usual distance sensors, such as capacitive sensors, typically cannot be used for remote laser machining. Accordingly, a remote distance determination with sufficiently high lateral and axial resolution is required.

Even with fixed-optics laser machining heads, i.e. laser machining heads without a scanner device or deflection optics, the topography of the machining area, such as the cutting front or the weld pool, and the surroundings is often measured for process monitoring or process control in order to assess the machining quality or to adjust or set process parameters.

DE 28 29 851 A1 describes an arrangement for measuring the distance between a metallic workpiece and a machining tool by means of capacitive distance sensors which enables the machining of workpieces with an irregular surface and in particular of protrusions extending in parallel to the tool path.

DE 10 2017 201 730 A1 relates to a method of welding and a welding arrangement, wherein a time-of-flight (ToF) detection device is used to detect an observation window on the workpiece that at least partially precedes the welding point.

DE 10 2015 015 651 B3 relates to a monitoring device for a laser machining system with a measuring beam source and a registration unit which detects a portion of the measuring beam reflected by the surroundings. The measuring beam is coupled, coaxially with the machining beam, into a laser machining head such that the measuring beam and the machining beam can be aligned with common positions in the surroundings.

DE 10 2012 212 278 A1 relates to an arrangement for creating bores or weld seams, wherein a distance between the workpiece and the arrangement is detected by means of a coaxial autofocusing unit. The autofocusing unit may comprise an OCT device, a ToF camera or a triangulation unit.

### SUMMARY OF THE INVENTION

The object of the present invention is to provide a laser machining system and a method which allow precise measurement of the workpiece for process monitoring and/or control.

It is a further object of the present invention to provide a laser machining system and a method which allow a three-dimensional or two-dimensional measurement of the workpiece for process monitoring and/or process control with a resolution in the sub-millimeter range.

It is a further object of the present invention to provide a laser machining system and a method which allow a three-dimensional measurement of the workpiece for process monitoring and/or process control in the immediate TCP surrounding area and/or in the (possible) machining area.

It is a further object of the present invention to provide a laser machining system and method which provide low-cost, flexible and versatile process monitoring and/or control for a machining process.

At least one of these objects is achieved by the subject matter of the independent claims.

According to one aspect of the present disclosure, a laser machining head for machining a workpiece, in particular a metallic workpiece, by means of a laser beam comprises: a housing in which at least one optics for directing the laser beam onto a machining point (TCP) on the workpiece is arranged; at least one continuous-wave lidar sensor, in particular at least one frequency-modulated continuous-wave lidar sensor and/or at least one amplitude-modulated continuous-wave lidar sensor, for detecting a distance to at least one point on the workpiece; and a control for process observation, in particular for monitoring and/or open-loop controlling and/or closed-loop controlling the machining process, based on the detected distance.

According to one aspect of the present disclosure, a laser machining system for machining a workpiece, in particular a metallic workpiece, by means of a laser beam comprises: a laser machining head comprising a housing in which at least one optics for directing the laser beam onto a machining point (TCP) on the workpiece is arranged, and comprising at least one continuous-wave lidar sensor, in particular at least one frequency-modulated continuous-wave lidar sensor and/or at least one amplitude-modulated continuous-wave lidar sensor, for detecting a distance to at least one point on the workpiece; and a control for process observation, in particular for monitoring and/or open-loop controlling and/or closed-loop controlling the machining process, based on the detected distance.

According to a further aspect, a method for performing, in particular for monitoring and/or open-loop controlling and/or closed-loop controlling, a laser machining process comprises the steps of: directing a laser beam onto a machining point (TCP) on a workpiece; detecting a distance to at least one point on the workpiece by means of a continuous-wave lidar sensor, in particular at least one frequency-modulated continuous-wave lidar sensor and/or at least one amplitude-modulated continuous-wave lidar sensor; and performing, in particular monitoring and/or open-loop controlling and/or closed-loop controlling, the laser machining process based on the detected distance. The step of directing the laser beam onto the workpiece and the step of detecting the distance can be carried out sequentially in time in this order one or sequentially in time in reverse order or simultaneously.

The control of the laser machining system or the laser machining head according to one of the embodiments of the present invention may be configured to carry out the method according to one of the embodiments of the present invention.

In the present disclosure, a process space is defined as a space within which the laser machining head can move relative to the workpiece, and in particular a space within which the laser machining head can move relative to the workpiece during the machining process and/or along a machining path specified for the machining process. In other words, the process space is defined with respect to the workpiece, i.e., the workpiece is stationary in the process space. The detection space is the area that can be detected by the lidar sensor or in which the lidar sensor can detect objects. The detection space refers to an area of the process space, i.e., the detection space lies within the process space. The detection space may be defined by a mounting height of the lidar sensor on the laser machining head and/or a receiving angle or opening angle of the lidar sensor. The TCP range or machining range is the range within which the laser beam can be directed with respect to the laser machining head. For a fixed-optics laser machining head, this may only be the beam path of the laser beam emerging from the laser machining head, i.e. a line that includes the TCP (tool center point, also called machining point) or the focal point of the laser beam. In the case of a scanner laser machining head, this may be a cone-shaped space determined by the beam deflection properties of the scanner device. In contrast, a TCP surrounding area refers to an area on the workpiece surrounding the TCP, e.g. with a radius of 15 cm or 10 cm or 5 cm around the machining point or TCP.

The present disclosure is thus concerned with the distance measurement and/or three-dimensional (3D) imaging for laser machining, in particular for laser cutting and laser welding, and/or for remote laser machining, in particular for remote laser cutting and remote laser welding, by means of at least one continuous wave lidar sensor (lidar: light detection and ranging, also known as LaDAR, laser detection and ranging). The continuous wave lidar sensor may also be referred to as a cw lidar sensor. In contrast to a pulsed lidar sensor or a ToF sensor, the continuous wave lidar sensor emits light continuously. In particular, the continuous wave lidar sensor may be a lidar camera, thus enabling 2D or 3D detection. Specifically, the two subgroups of AMCW (amplitude-modulated continuous wave, also known as indirect time-of-flight, iToF) lidar sensors and FMCW (frequency-modulated continuous wave) lidar sensors may be used for the continuous wave lidar sensor.

Preferably, a TCP surrounding area, i.e. an area on the workpiece surrounding the TCP, e.g. with a radius <20 cm around the machining point or TCP, can be measured. This allows for process observation that can be used for process open-loop controlling and/or closed-loop controlling. Three-dimensional information may be obtained, for example, from the cutting kerf and/or the cutting front during laser cutting, or from the weld seam and/or the melt pool and/or the keyhole during laser welding, as well as optionally from the adjacent material surface. Information may be sensed before, during and/or after the process (pre-process, in-process, post-process) and used for preparation, process closed-loop control and quality analysis. Closed-loop control parameters may be, for example, the laser focus position, laser power, inclination and/or feed rate, as explained below.

In particular, for a laser machining head with a deflection device or scanner device, a TCP area or machining area may be measured, which is defined, for example, by the maximum deflection of the laser beam in the machining plane. The maximum deflection may be given by the deflection optics or scanning elements used. By sensing topographical data, a precise determination of the component geometry can be achieved so that areas where the laser beam is to machine the material can be identified. In addition, process observation for process control or process analysis, for example to determine the focus position or the weld seam depth, may be enabled.

The laser machining system according to the invention and/or the method according to the invention provides very extensive options for process observation due to the enormous versatility of the lidar sensor with a single implementation. In addition, the use of a continuous wave lidar sensor allows for a resolution in the sub-millimeter range, preferably a resolution between 0.05 mm and <1.0 mm.

The laser machining system or the method according to one of the aspects listed above may comprise one or more of the following features:

The laser machining head may be a laser machining head for carrying out a machining process, in particular for laser cutting, laser welding, laser deposition welding, laser soldering, laser drilling, etc., on the workpiece by means of the laser beam. The workpiece may in particular be a metallic workpiece. The laser machining head may be a scanner laser machining head, i.e. the laser machining head may comprise a scanner device having at least one scanner element for deflecting the laser beam in at least one direction, preferably in two directions perpendicular to one another, perpendicular to a beam propagation direction. The scanner device or the scanner element may comprise a mirror (scanner mirror) that can be pivoted about at least one axis. In case of a scanner laser machining head, the axis of the beam path of the laser beam or the beam path of the laser beam refers to the “neutral” scanner position (x=0, y=0), i.e. to the undeflected beam path. The laser machining head may have focusing optics. An optical axis of the focusing optics usually extends identically or coaxially to the axis of the beam path of the laser beam. In case of a scanner laser machining head, the focusing optics may be an F-theta lens.

The optics may comprise collimating optics for collimating the laser beam and/or focusing optics for focusing the laser beam. The optics may comprise one or more optical elements, e.g. a lens, a lens group, a mirror, a beam splitter, a beam deflector, a deflecting or scanning mirror, etc.

The laser machining head may comprise a plurality of lidar sensors. Alternatively or additionally, the lidar sensor may comprise a plurality of detectors and/or a plurality of emitters.

The lidar sensor is configured to measure a distance to at least one point on the workpiece or on the workpiece surface. The distance may be measured with respect to the laser machining head and/or with respect to the lidar sensor and/or with respect to any other reference, e.g. with respect to another measuring point on the workpiece surface. The lidar sensor may be configured to measure the workpiece at a single point or in an area. The lidar sensor may be configured to measure a grid of points on the workpiece. For example, a planar measurement of the workpiece or three-dimensional imaging may be achieved when the lidar sensor is configured as a lidar camera. The lidar sensor may be configured and/or arranged on the laser machining head so as to measure at least one distance on the workpiece within a machining area of the laser machining head and/or within a TCP surrounding area, for example with a radius of 20 cm, 15 cm or 10 cm or 5 cm around the TCP. In other words, the lidar sensor may be configured for three-dimensional imaging and/or three-dimensional detection of a machining area of the laser machining head and/or within a TCP surrounding area. In particular, the lidar sensor may be configured to measure an area on the workpiece surface with a resolution in the sub-millimeter range.

The lidar sensor comprises at least one emitter for emitting measuring light and/or for illuminating the workpiece and/or for illuminating the detection space. The lidar sensor further comprises at least one detector for detecting back reflections of the measuring light. The emitter and the detector may be arranged together, e.g. in a sensor housing or sensor module. In other words, the emitter and the detector may have an (almost) identical or coaxial beam path, i.e. the illumination beam path and the detection beam path may be identical or coaxial. Alternatively, the emitter and the detector may be spatially separated from one another. For example, the illumination beam path and the detection beam path may be completely or at least partially separated from each other. A plurality of emitters per detector, or also a plurality of detectors per emitter, may be provided.

In one example, the at least one emitter may be arranged outside of the housing, e.g. on the underside of the housing, and a beam path of the detector may extend at least partially in the housing.

The emitter may be configured for the most homogeneous illumination of the workpiece possible. For example, a plurality of emitters may be arranged like a ring around an axis of the beam path of the laser beam or around an optical axis of the focusing optics and/or may each have an optical axis that is inclined with respect to the axis of the beam path of the laser beam or the optical axis of the focusing optics. In a preferred embodiment, the emitters are arranged at equal angular distances with a constant radius from the axis of the beam path of the laser beam and the optical axis of the focusing optics, respectively.

In this disclosure, a beam path of the lidar sensor refers to a beam path from the emitter to the workpiece and from the workpiece to the detector. A beam path of the emitter refers to the beam path from the emitter to the workpiece and a beam path of the detector refers to the beam path from the workpiece to the detector.

The detector and/or the emitter, or the lidar sensor, may be arranged in the laser machining head. In case of a scanner laser machining head, the detector and/or the emitter or the lidar sensor may have a beam path that is guided or extends over the scanner device. In other words, the detection space of the detector or the lidar sensor may be guided or scanned over the workpiece by means of the scanner device. The individual images may be combined by the control system or by computer assistance. The detector and/or the emitter, or the lidar sensor, may have a beam path that is at least partially or completely coaxial with the beam path of the laser beam. This allows for the TCP area to be viewed at a steep angle.

The detector and/or the emitter or the lidar sensor may be arranged, for example, at a laser beam entry port, i.e. an entry port for coupling the laser beam into the laser machining head, or at a fiber socket of the laser machining head. The fiber socket may be configured to hold an optical fiber in order to couple the laser beam guided in the optical fiber into the laser machining head.

The laser machining head may comprise a beam splitter for coupling a beam path of the detector and/or the emitter or the lidar sensor with the beam path of the laser beam. In other words, a beam path of the detector and/or emitter or lidar sensor may be coupled into or out of the beam path of the laser beam using a beam splitter. Thus, the beam path of the detector and/or the emitter or the lidar sensor may be partially coaxial with the beam path of the laser beam. In this case, an exit opening of the laser machining head or an exit opening of a nozzle of the laser machining head may limit a measurable area on the workpiece surface or the detection space. Since the exit opening is typically much larger than the TCP area, a significant area on the workpiece surface is nevertheless covered.

The detector and/or emitter, or the lidar sensor, may be attached to the housing on the outside. For example, the detector and/or emitter or the lidar sensor may be arranged on a bottom side of the housing and/or on a chamfered edge of the housing and/or on a stand mounted to the housing. This allows for the TCP area to be viewed at a shallow angle. In addition or as an alternative, a mirror may be mounted on the laser machining head in the beam path of the emitter and/or the detector by means of a holder in order to guide the beam path at a shallow angle to the workpiece surface (so-called folded beam path).

In one example, the detector may have a beam path that is at least partially within the housing and/or coaxial with the beam path of the laser beam, and the emitter may have a beam path that is entirely outside of the housing.

The detector and/or the emitter or the lidar sensor may have a beam path extending entirely outside of the housing. In one example, the lidar sensor may be attached to a bottom side of the housing. In another example, the lidar sensor may be attached via a stand-like mount to the outside of the housing, i.e. at a distance from the housing.

An angle and/or an orientation of the detector and/or the emitter may be adjustable, in particular manually, motorically, or by means of an actuator. The detector and/or the emitter may be arranged on a piezoelectric element in order to adjust an angle and/or an orientation and/or an inclination of the detector or the emitter. In other words, an angle between the workpiece and a center axis of the detection space (or an optical axis) of the detector and/or a center axis of an illumination space (or an optical axis) of the emitter may be adjusted by means of the piezoelectric element. This allows a view into the machining area or TCP surrounding area from different angles.

A beam-shaping optics may be arranged in the beam path of the lidar sensor or the detector and/or the emitter, for example between a beam splitter for coupling into or out of the beam path of the laser beam and the lidar sensor or the detector and/or emitter. The beam-shaping optics may be arranged outside of the beam path of the laser beam. The beam-shaping optics may comprise a diffractive optical element or a spatial light modulator. In particular, active beam-shaping optics, configured to adjust a detection angle of the lidar sensor or the detector or an illumination angle (divergence angle of the measuring light) of the emitter may be arranged in the beam path of the lidar sensor or the detector and/or emitter. The active beam-shaping optics may form a telescopic arrangement in combination with a focusing optics of the laser machining head. In this way, the size of an area detectable by the lidar sensor or the detector may be adjustable and/or different measurement grids may be realized.

The lidar sensor or the detector may comprise at least one photodiode, a diode array, a CMOS sensor, at least one avalanche photodiode, etc. The lidar sensor or emitter may comprise a beam source, in particular a laser beam source, a semiconductor laser, a beam source array, a laser beam source array, at least one LED, an LED array, at least one VCSEL, a VCSEL array, etc. The emitter or the beam source may be a laser beam source or a beam source array in the visible, near-infrared or infrared frequency range.

The lidar sensor may also include a beam-shaping optics, for example a diffuser, a diffractive element, a wide-angle lens or a modulation optics.

A wavelength of the laser beam for machining the workpiece (also referred to as a machining laser beam) may be different from the wavelength or wavelength range of the measurement light or lidar sensor or emitter. The lidar sensor may comprise a filter or spectral filter blocking at the wavelength of the laser beam used to machine the workpiece. Due to the high intensity of the laser beam, the back reflection thereof should not reach the lidar sensor. At the same time, a filter, such as a polarization filter, may be used to filter the back reflection of the measuring light in such a way that the reflection of the measuring light that reaches the sensor is as unpolarized as possible. Preferably, a wavelength or wavelength range of the measuring light or of the lidar sensor or of the emitter is selected depending on the machining process and/or the workpiece material, for example such that the measuring light is absorbed or reflected as little as possible by optical elements in the beam path of the lidar sensor or of the emitter and/or such that reflection or absorption properties for different materials are quite similar, e.g. 1550 nm.

Alternatively, the laser beam for machining the workpiece may have the same wavelength as the measuring light or the lidar sensor or the emitter, in particular when the detection by means of the lidar sensor and the machining by means of the laser beam are separated in time. This may reduce the risk of chromatic aberration since the optics of the laser machining head is usually configured for the wavelength of the laser beam.

The lidar sensor may further comprise a protective glass for protecting against contamination, e.g. from smoke or splashes, and/or a cross-jet device for creating an air curtain.

The lidar sensor or the emitter and/or the detector may be pivotally and/or displaceably mounted on the housing such that the position of the detection space and/or the optical axis of the lidar sensor or the emitter or the detector is adjustable. The lidar sensor or the emitter and/or the detector may be pivotable about an axis that extends perpendicularly to the optical axis of the focusing optics and/or horizontally and/or in parallel to a side of the housing. In other words, a radiation and/or detection angle of the lidar sensor or the emitter or the detector may be adjustable. The lidar sensor or the emitter and/or the detector may be movable in parallel to the optical axis of the focusing optics and/or in the vertical direction on the housing. In other words, the mounting height of the lidar sensor or the emitter or the detector may be adjustable, in particular manually, motorically, or by means of an actuator. The mounting height and the emission and detection angles of the lidar sensor and the detector, respectively, are decisive for the size of the detection space and in particular for the size of a measuring area.

The housing may comprise a guide, e.g. a rail, along which the lidar sensor or the emitter and/or the detector can be displaced. An edge of the housing, e.g. a lower edge, and/or a corner of the housing, e.g. a lower corner, may have a chamfer or a chamfered surface on which the lidar sensor or the emitter and/or the detector is attached.

The lidar sensor or the emitter and/or the detector may include a holder. The lidar sensor or the emitter and/or the detector may be received in the holder. The holder may be attached to the housing in such a way that it can be pivoted and/or displaced and/or released and/or rotated. Alternatively or additionally, the emitter and/or the detector may be arranged in the holder such that it can be pivoted and/or displaced. The lidar sensor or the emitter and/or the detector may be motorized and/or automated such that it can be pivoted about an axis perpendicular to the optical axis of the focusing optics and/or about a horizontal axis.

The lidar sensor or the emitter and/or the detector may be oriented inward with respect to a center axis of the laser machining head or toward an optical axis of the optics, in particular a focusing optics. An optical axis of the lidar sensor or a center axis of the detection space (i.e., the center axis passing through the lidar sensor and/or dividing the detection angle into equal parts) may form an angle not equal to 0° or 180°, i.e., preferably an angle smaller than 90°, with an optical axis of a focusing optics of the laser machining head.

Alternatively, the lidar sensor or the emitter and/or the detector may be directed outwards with respect to a central axis of the laser machining head or away from an optical axis of the optics, in particular a focusing optic. In this case, a mirror may be attached to the laser machining head by means of a holder in the beam path of the lidar sensor or the emitter and/or the detector in order to direct the beam path into the TCP area or into the TCP surrounding area.

The detection space of the lidar sensor may include the machining point (TCP). Alternatively, the TCP may be outside of the detection zone of the lidar sensor. The detection zone of the lidar sensor may include the machining point (TCP) and a TCP surrounding area. The TCP surrounding area may be defined as an area on the workpiece within a radius of 20 cm, 15 cm, 10 cm, or 5 cm around the TCP. The detection space of the lidar sensor may be at least partially within the TCP surrounding area and/or include an area of the workpiece surface. The detection space of the lidar sensor may also be completely within the TCP surrounding area. The detection space of the lidar sensor may be limited by the detection angle of the lidar sensor and by the workpiece or the workpiece surface. The detection space of the lidar sensor may be arranged (at least partially) in the advance and/or wake of the laser machining head and/or to the side of the laser machining head. In the advance of the laser machining head, there is an area of the workpiece to be machined (e.g. a joining edge), and in the wake there is an area of the workpiece that has already been machined (e.g. a weld seam or cut edge).

The control system may be configured to adjust at least one process parameter based on the detected distance. The process parameter may be selected from: machining speed, feed rate (i.e. relative speed between laser machining head and workpiece), laser power, laser power modulation, pulse-on time, pulse-off time, pulse peak power, focus position of the laser beam, position of the laser beam, magnification ratio of the optical elements of the laser machining head (i.e. for example in the beam path of the laser beam), angle of incidence of the laser beam on the workpiece, an angle of a scanner element for deflecting the laser beam, and pressure of a process gas.

The control system may be configured to determine or measure at least one of the following parameters of the machining process based on the detected distance or distances: a component geometry, a position of a cutting front, a position of a cut edge, a cutting front angle, a cutting front length, a keyhole depth, a keyhole topography, a keyhole stability, a weld seam position, a weld seam geometry, a joining edge between two workpieces to be welded, a cutting gap closure, spatter formation, a diameter of a piercing hole, an ejection height of a piercing hole, an ejection diameter of a piercing hole, a piercing depth and a breakthrough. Based thereon, the laser machining process may be monitored and/or open-loop controlled and/or closed-loop controlled and/or a machining quality may be determined and/or process parameters may be adjusted or set.

The control system may be configured to detect a defect in the machining area, in particular a defect in the workpiece(s) or a defect in a workpiece holder or clamping device, such as a broken hold-down device, protruding contact wires, warping or other mechanical changes outside of the norm, based on the distance(s) detected.

The control system may be configured to determine a degree of contamination of the optics based on the signal detected by the lidar sensor.

The lidar sensor may have a lateral resolution of less than 1.0 mm, preferably less than 0.5 mm, in particular between 0.005 and 1.0 mm. The lidar sensor may be configured to scan its detection space at different (lateral and/or axial) resolutions. In other words, the (lateral and/or axial) resolution of the lidar sensor may be adjusted. The control system may be configured to adjust the (lateral and/or axial) resolution of the lidar sensor.

The laser machining head may comprise a module that includes the at least one lidar sensor or the at least one emitter and is detachably attached to the housing. The module may be coaxially attached to the housing. The module may have an opening for the beam path of the laser beam, i.e. for allowing the laser beam to pass therethrough in the center. The module may be attachable between the housing and a nozzle or to a bottom side of the housing. The module may include an interface for conveying data from the lidar sensor or from the detector to an external control or computing unit. The module may include an electronic component, such as a module control and/or a lidar control for controlling the at least one lidar sensor or the emitter and possibly other components of the module. The module control or lidar control may be programmed on the basis of FPGA. The module may comprise a gas connection for a cross-jet device. The module may comprise a lower edge with a chamfer or a chamfered lower edge and/or a chamfered corner on which at least one of the lidar sensors or the emitter is arranged.

The emitter and/or the detector, or the lidar sensor, may be arranged on a chamfered edge or lower edge of the housing or module facing the machining point. Alternatively, the emitter and/or the detector, or the lidar sensor, may be arranged on a chamfered edge or lower edge of the housing or module facing away from the machining point, wherein the beam path is directed into the machining area of the laser machining head and/or into the TCP surrounding area by means of a mirror arrangement. The mirror arrangement may be attached to the housing or to the module in a stand-like manner. One angle of the mirror arrangement may be adjustable.

The module may comprise a plurality of, in particular at least four, lidar sensors arranged around the optical axis of the focusing optics. The module or at least part of it may be attached to the housing such that it can be rotated either by hand or by motor.

The control may be configured to control the at least one lidar sensor and/or to evaluate data from the at least one lidar sensor. The control may be configured to generate a distance signal from the data detected by the at least one lidar sensor. The control may be configured to use the lock-in method to amplify the signal-to-noise (SNR) ratio. In this case, the signal detected by the detector may be modulated with the amplitude or frequency modulation period, and corresponding correlated back reflections from the background of the laser beam may be filtered using Fourier analysis. The control may be connected to, or may be integrated into, an external control or computing unit (wired or wireless) for unidirectional or bidirectional data exchange.

A plurality of lidar sensors or a plurality of emitters and/or a plurality of detectors may be arranged in a ring-like fashion around the beam path of the laser beam and/or around an optical axis of the focusing optics and/or at a variable inclination to the TCP. A ring center may lie on an axis of the beam path and/or on the optical axis of the focusing optics. Preferably, the lidar sensors or emitters or detectors are arranged at equal angular distances with a constant radius around the TCP and/or around the beam path of the laser beam and/or around the optical axis of the focusing optics. The plurality of lidar sensors or emitters and/or detectors may be arranged radially, preferably in uniform angular segments or spacings, around the fiber socket or the laser beam entry port of the laser machining head or on a bottom side of the housing. The individual lidar sensors or emitters and/or detectors may have the same or different angles of inclination with respect to the beam path of the laser beam or with respect to an optical axis of the focusing optics. The inclination angles of the lidar sensors or emitters or detectors may be adjustable, for example manually, motorically, or by means of an actuator such as a piezoelectric element. Here, the angle of inclination of the lidar sensors or emitters or detectors is defined with respect to an optical axis of the lidar sensors or emitters or detectors and/or to a center axis of the detection space or the illumination space. This allows a view into the TCP area at a steep angle and/or from different viewpoints around the TCP.

A plurality of lidar sensors or emitters and/or detectors may be arranged rotatably (e.g. by motor or manually) about the beam path of the laser beam and/or about an optical axis of the focusing optics on the laser machining head. This allows for the TCP or the machining area, for example the cutting front, to be viewed from behind in the feed direction for any machining contour.

When the detection spaces of the lidar sensors overlap, the lidar sensors with overlapping detection spaces may be sensitive to different wavelengths (ranges). For example, filters for different wavelengths (ranges) may be arranged in front of the detectors of the lidar sensors with overlapping detection spaces and/or the emitters of the lidar sensors with overlapping detection spaces may emit in different wavelength (ranges). The lidar sensors with overlapping detection spaces may also be driven alternately, e.g. by a common lidar control of the lidar sensors, which may also be the control of the laser machining head or may be integrated in it. In other words, these lidar sensors may be controlled in such a way that their detection periods and/or their emission or illumination periods do not overlap.

The control system may be configured to determine a distance from the the laser machining head to the workpiece surface, e.g. along the optical axis of the focusing optics. The lidar sensor may thus also be used to measure the distance of the cutting nozzle to the top side of the sheet metal or to contours located to the side. This would allow capacitive distance sensors to be calibrated in absolute units or to even be replaced.

### BRIEF DESCRIPTION OF THE FIGURES

Examples of the disclosure are shown in the figures and are described in more detail below. In the drawings:

FIGS. 1a and 1b are schematic diagrams of the laser machining head with at least one lidar sensor, the beam path of which extends in the housing of the laser machining head, according to embodiments of the present disclosure;

FIGS. 2a and 2b are schematic diagrams of the laser machining head with at least one lidar sensor arranged outside of the housing of the laser machining head according to embodiments of the present disclosure;

FIGS. 3a and 3b are schematic diagrams of the laser machining head with separately arranged detectors and emitters of a lidar sensor according to embodiments of the present disclosure;

FIG. 4a is a schematic diagram of a laser machining head with a lidar sensor attached to the housing via a stand-like mount according to an embodiment of the present disclosure; FIG. 4b is a schematic diagram of a laser machining head with a detector attached to the housing by means of a stand-like mount and an emitter arranged outside of the housing of the laser machining head according to an embodiment of the present disclosure;

FIGS. 5a and 5b are schematic diagrams of the laser machining head with at least one lidar sensor arranged on a chamfered lower edge of a sensor holder according to embodiments of the present disclosure;

FIGS. 6a to 6d show various arrangements of detectors and emitters of lidar sensors arranged on a lower side of the laser machining head housing according to embodiments of the present disclosure;

FIG. 7a is a schematic diagram of a distance measurement by at least one lidar sensor during laser cutting according to an embodiment of the present disclosure;

FIG. 7b is a schematic diagram of a distance measurement by at least one lidar sensor during laser welding according to an embodiment of the present disclosure; and

FIG. 8 is a flow chart for a method according to an embodiment of the present disclosure.

### DETAILED DESCRIPTION OF THE FIGURES

In the following, the same reference symbols are used for the same and equivalent elements, unless otherwise noted.

This invention is intended to measure the topography of the process area, such as the cutting front or the weld pool, in three dimensions using one or more lidar sensors, for example lidar cameras. Herein, information about a distance to at least one point on the workpiece may be precisely measured in order to observe the machining process, in particular to monitor and/or open-loop control and/or closed-loop control it. For example, based on a detected distance, at least one process parameter such as a machining speed, a feed rate, a laser power, a focus position of the laser beam, a position of the laser beam, an angle of incidence of the laser beam on the workpiece, an angle of a scanning element for deflecting the laser beam, and a pressure of a process gas may be determined.

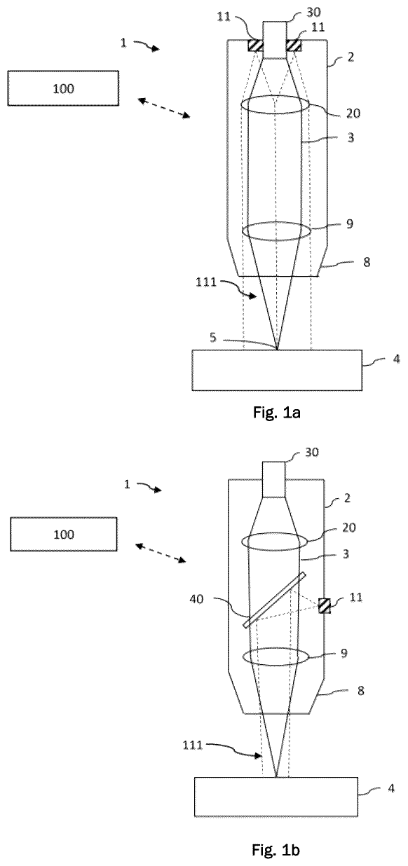

FIGS. 1 to 5 show a laser machining head 1, for example for laser cutting or laser welding, with a fiber socket or a laser beam entry port 30, through which a laser beam 3 is coupled into the housing 2. The laser beam 3 is then collimated by a collimating optics 20 and subsequently focused by a focusing optics 9. After the focused laser beam 3 has left the laser machining head 1 through an exit opening of the laser machining head, for example from a nozzle 8 of the laser machining head, it hits the workpiece 4 and forms a machining point or TCP 5 on the workpiece 4. The workpiece is melted at the machining point 5, for example in order to form a cutting joint in a workpiece 4 or a weld seam between two workpieces 4. Furthermore, a continuous-wave lidar sensor 11, 11a, 11b, which measures or detects at least one distance to a point on the workpiece, is arranged on the laser machining head 1. The lidar sensor may be configured as a frequency-modulated or amplitude-modulated continuous-wave lidar sensor. The distance to the workpiece may be detected with respect to the lidar sensor 11 or the laser machining head 2, in particular with respect to a bottom side of the housing 2 or a bottom side of a nozzle 8. Alternatively, the measurement may be referenced by at least one further measurement point. In this case, the depth information is not determined absolutely but relative to this so-called trigger measurement point. The trigger measurement point may lie on the workpiece surface or be given by the opening of the nozzle 8.

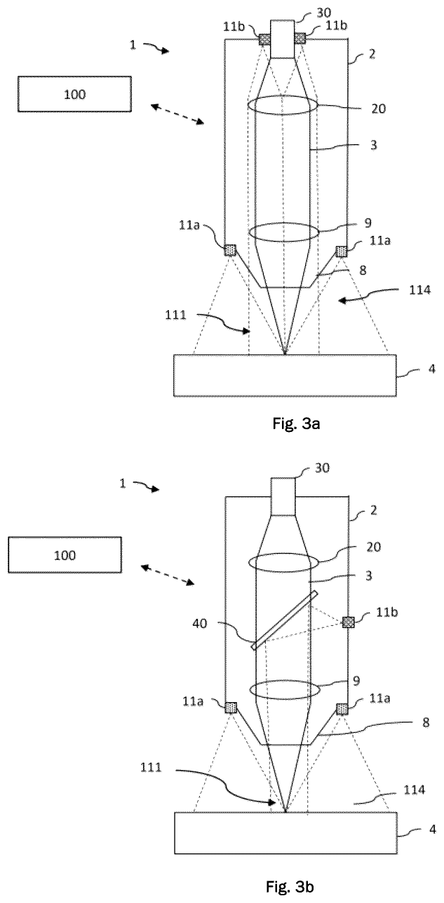

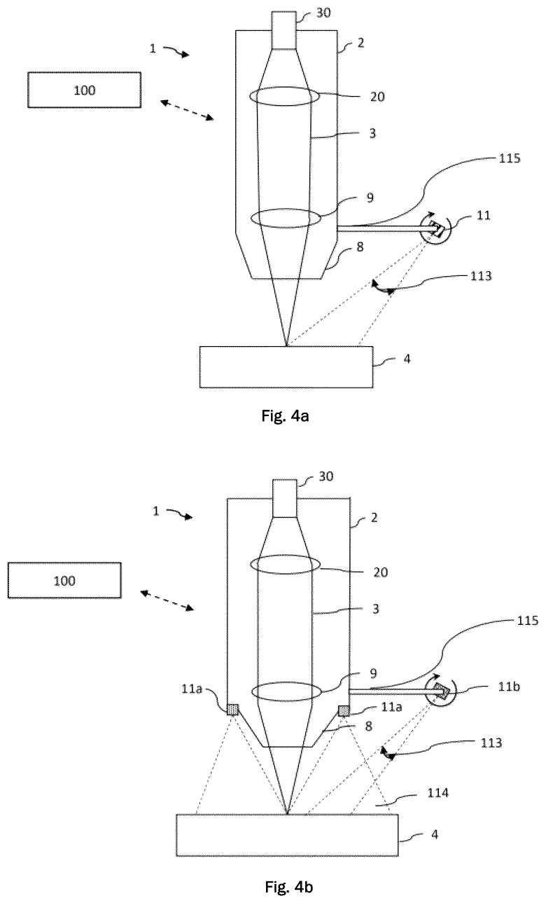

FIGS. 1 to 5 show different embodiments of a laser machining head 1 which may be combined with each other in any way. FIGS. 1a, 1b, 2a, 2b, 4a, 5a and 5b show various arrangements of at least one lidar sensor 11 on the laser machining head 1, which comprises at least one emitter and at least one detector in a common arrangement (shown only as sensor 11). FIGS. 3a, 3b and 4b show various arrangements of at least one lidar sensor on the laser machining head 1, wherein the at least one emitter 11a and the at least one detector 11b are arranged separately from one another. In the lidar sensor 11 with a detector and emitter arranged in common, the beam path of the emitter (also called the illumination beam path) and the beam path of the detector (also called the detection beam path) may extend largely identically, i.e. the optical axes of the emitter and the detector may extend in parallel or even coaxially. In the case of the lidar sensor 11 with a separately arranged detector and emitter, for example, the beam path of the emitter may extend outside of the housing and the beam path of the detector may extend inside the housing. The orientation of the lidar sensor 11 or the emitter 11a and/or the detector 11b may be adjustable, in particular manually, motorically, or by means of an actuator, e.g. a piezoelectric element. Furthermore, the laser machining head 1 includes a control 100 for monitoring and/or open-loop controlling and/or closed-loop controlling the machining process based on the at least one detected distance. The control may carry out a method for performing a laser machining process. In the method, the laser beam 3 is directed to the machining point 5 on the workpiece 4 and a distance to at least one point on the workpiece 4 is detected by the lidar sensor 11. The lidar sensor 11 may acquire data during the machining process, or also before or after the machining process. The lidar sensor 11 may measure a distance to one or more points in advance of the machining point 5 (pre-process: e.g. at a joining edge), at the machining point 5 (in-process: e.g. in the keyhole) or in the wake of the machining point 5 (post-process: e.g. on a weld seam). This means that the at least one point on the workpiece 3 for which the distance is determined may, for example, include the machining point 5 and/or a point in the cutting joint or on the weld seam 6 and/or a point in an area on the workpiece that is yet to be machined. The lidar sensor 11 may also detect an area on the workpiece in advance of the machining point, around the machining point or in the wake of the machining point. The laser machining process may then be monitored and/or controlled based on the detected distance. Data from an area of the workpiece that is yet to be machined, i.e. from an area of the workpiece in advance, and/or from an area around the machining point 5 may be used to open-loop and/or closed-loop control the machining process. Data from an area of the workpiece that has already been machined, i.e. from an area of the workpiece in the wake, may be used for process monitoring, in particular for determining quality, and/or for closed-loop control.

The individual arrangements or combinations of the at least one lidar sensor and/or the at least one emitter 11a and detector 11b in or on the housing of the laser machining head 1, which are shown in FIGS. 1 to 5, may be combined with each other in any way and are therefore by no means to be regarded as limiting.

FIG. 1a shows a plurality of lidar sensors 11 arranged around the fiber socket or laser beam entry port 30 on an upper side of the housing 2 of the laser machining head 1. The lidar sensors 11 may be arranged in a circle or ring (preferably at equal distances from one another) around the fiber socket 30 and/or the laser beam entry port and/or around the beam path of the laser beam 3. Also, only one lidar sensor 11 may be arranged next to the fiber socket 30 and/or next to the beam path of the laser beam 3. The lidar sensor 11 is configured to detect distances to points or objects in a detection space 111. Here, the beam path of the lidar sensor 11 extends inside the housing 2 through the collimating optics 20 and the focusing optics 9. The beam path of the lidar sensor 11 may extend in parallel, possibly even coaxially, to the beam path of the laser beam 3.

FIG. 1b shows a lidar sensor 11, the beam path of which is coupled into the beam path of the laser beam 3 via a beam splitter 40. The beam path of the lidar sensor 11 passes through the beam splitter 40, for example a dichroic mirror, and the focusing optics 9 and Substitute Specification-Clean then exits the laser machining head. In other words, the beam path of the lidar sensor 11 is coupled with the beam path of the laser beam 3 by the beam splitter 40. The beam path of the lidar sensor 11 extends inside the housing 2, in segments and sections in parallel, possibly even coaxially, to the beam path of the laser beam 3.

In the arrangements shown in FIGS. 1a and 1b, the measurable area is limited by the exit opening of the laser machining head 1 or the nozzle 8. However, since the exit opening is usually considerably larger than the machining area, a significant part of the workpiece surface is still covered.

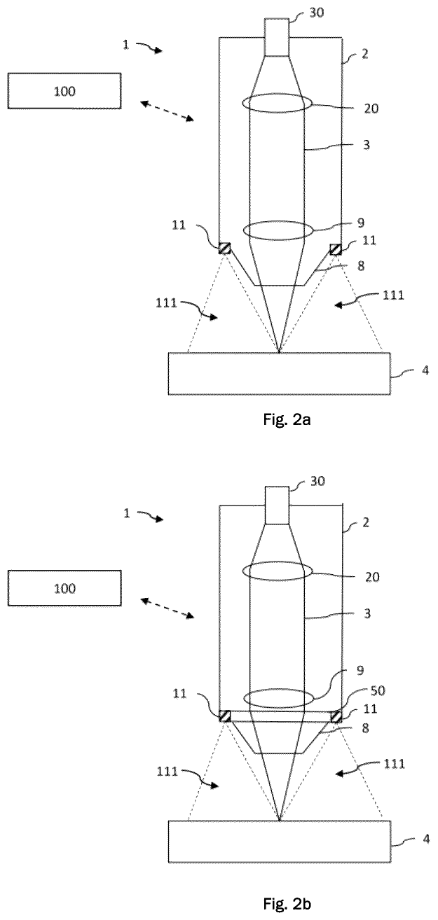

FIG. 2a shows a plurality of lidar sensors 11 arranged on a bottom side of the housing 2. The lidar sensors 11 may be arranged in a circle or ring (preferably with equal distances from each other) around the beam path of the laser beam 3 or around the optical axis of the focusing optics 9. In particular, the lidar sensors 11 may be arranged around a nozzle 8 of the laser machining head on an outer surface of the housing 2, to which the nozzle 8 is attached. The beam path of the lidar sensors 11 extends completely outside of the housing 2. In this way, optical errors, e.g. chromatic aberration, by optical elements may be avoided. The lidar sensors 11 may be attached to the housing 2 such that they can be pivoted, e.g. about a horizontal axis or about an axis that is perpendicular to the optical axis of the lidar sensor 11 and/or to the optical axis of the focusing optics 9. For example, an orientation of the lidar sensor 11 may be adjustable by means of a piezoelectric element. Of course, only one lidar sensor 11 may also be arranged on the bottom side of the housing 2.

FIG. 2b shows a plurality of lidar sensors 11, the beam path of which also extend completely outside of the housing 2 of the laser machining head 1. The lidar sensors 11 may be arranged in a circle or ring (preferably with equal distances from each other) around the beam path of the laser beam 3 or around the optical axis of the focusing optics 9. In contrast to FIG. 2a, the lidar sensors 11 in FIG. 2b are arranged in a module 50 that is detachably attached to the housing 2, for example on a bottom side of the housing 2 or between the housing 2 and the nozzle 8. The sensor arrangement of the module 50 may be rotatable, e.g. around an optical axis of the focusing optics 9 or around the beam path of the laser beam 3. For example, the sensor arrangement of the module 50 may be rotated by a motorized unit of the module. An axis of rotation may be coaxial with the optical axis of the focusing optics 9. In addition or as an alternative, the lidar sensors 11 may be attached to the module 50 so as to be pivotable, e.g. about a horizontal axis or about an axis perpendicular to the optical axis of the lidar sensor 11 and/or to the optical axis of the focusing optics 9. For example, the orientation of a lidar sensor 11 may be adjustable by means of a piezoelectric element.

FIG. 3a shows a plurality of lidar sensors wherein the emitter 11a and detector 11b are arranged separately. For example, the emitters 11a may be arranged outside of the housing 2 or may have a beam path extending completely outside of the housing 2. The detectors 11b, on the other hand, may have a beam path extending inside the housing 2 or may be arranged inside the housing 2. The emitters 11a may be arranged in correspondence to the lidar sensors 11 of FIGS. 2a and 2b. The detectors 11b may be arranged in correspondence to the lidar sensors 11 of FIG. 1a.

FIG. 3b also shows a plurality of lidar sensors, wherein the emitters 11a and detectors 11b are arranged separately. Again, the emitters 11a may be arranged outside of the housing 2 or have a beam path extending completely outside of the housing 2, and the detectors 11b may have a beam path extending inside the housing 2 or may be arranged inside the housing 2. The emitters 11a may be arranged corresponding to the lidar sensors 11 of FIGS. 2a and 2b. The detectors 11b can be arranged in correspondence to the lidar sensors 11 of FIG. 1b, i.e. have a beam path that is coupled with the beam path of the laser beam 3 by means of a beam splitter 40.

Each detector 11b has a detection space 111, each emitter 11a has an illumination space 114. The illumination spaces 114 of different emitters 11a and the detection spaces of different detectors 11b may be separate or may overlap. A detector 11b may receive back reflections of light from a plurality of emitters 11a. Therefore, only one detector 11b and a plurality of emitters 11a may be arranged on the laser machining head. Likewise, one emitter 11a may illuminate the workpiece for a plurality of detectors 11b. In this case, only one emitter 11a and a plurality of detectors 11b may be arranged on the laser machining head. Of course, also only one emitter 11a and one detector 11b may be arranged on the laser machining head.

FIG. 4a shows a lidar sensor 11 attached to the housing 2 by a stand-like sensor holder 115. In this way, the lidar sensor 11 may be arranged at a distance from the laser machining head. Of course, a plurality of lidar sensors 11 may be attached to the housing 2 in this manner. The lidar sensor 11 may be arranged on the sensor holder 115 so as to be pivotable, e.g. about a horizontal axis or about an axis perpendicular to the optical axis of the lidar sensor 11 and/or to the optical axis of the focusing optics 9. Thus, an orientation of the lidar sensor 11 or an orientation of the optical axis of the lidar sensor or the detection space 112 of the lidar sensor 11 may be adjustable. The detection space 112 of the lidar sensor 11 is determined by the detection angle 113 of the lidar sensor 11 and the orientation of the lidar sensor 11. In case of a plurality of lidar sensors 11, different orientations may be set.

FIG. 4b shows a detector 11b attached to the housing 2 by means of a stand-like sensor holder 115. Of course, also a plurality of detectors 11b may be attached to the housing 2 in this manner. The detector 11b may be arranged on the sensor holder 115 so as to be pivotable, for example about a horizontal axis or about an axis perpendicular to the optical axis of the lidar sensor 11 and/or to the optical axis of the focusing optics 9. One or more emitters 11a may be arranged outside of the housing 2, e.g. on a bottom side of the housing 2. The emitters 11a may be arranged like lidar sensors 11 in FIGS. 2a and 2b.

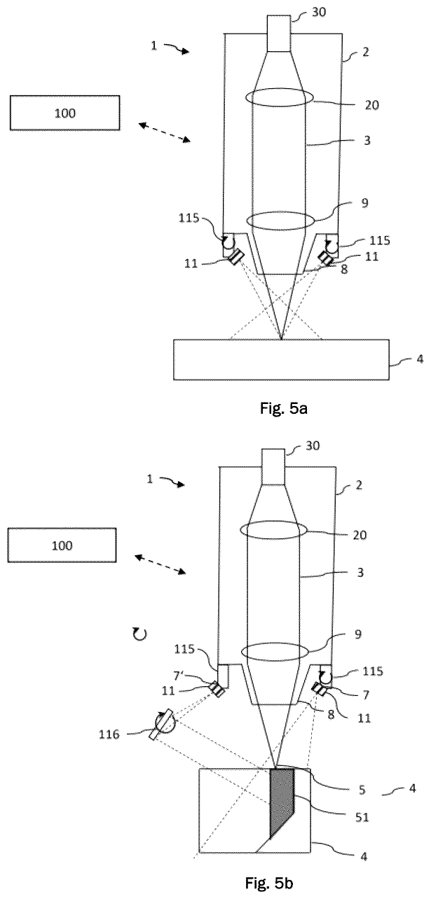

FIGS. 5a and 5b show lidar sensors 11, the beam paths of which extend outside of the housing 2. The lidar sensors 11 are arranged on a chamfer 7, 7′ formed on a sensor holder 115 or on the housing 2 itself, in particular on a lower edge of the housing. The chamfer 7, 7′ forms a surface extending at an angle to the optical axis of the focusing optics 9 or to the beam path of the laser beam 3. The lidar sensors 11 may be arranged on the chamfer 7, 7′ in such a way that an optical axis of the respective lidar sensor 11 or a center axis of the detection space of the respective lidar sensor 11 is oriented substantially perpendicularly to the chamfer 7, 7′. The sensor holder 115 may be rotatable, i.e. around the optical axis of the focusing optics 9 or around the beam path of the laser beam 3, or it may be fixed to the housing 2 or formed integrally therewith. The chamfer 7, 7′ may also be formed directly on the housing 2. The lidar sensors 11 may be arranged on the chamfer 7, 7′, for example, so as to be pivotable by means of piezoelectric elements, e.g. around a horizontal axis or around an axis perpendicular to the optical axis of the lidar sensor 11 and/or to the optical axis of the focusing optics 9, such that an orientation of the lidar sensors 11 is adjustable.

In FIG. 5a, the chamfer 7 is directed inwards, i.e. facing the beam path of the laser beam 3 or the optical axis of the focusing optics 9. In other words, the chamfer 7 is oriented such that the beam path of the lidar sensors 11 is directed directly (i.e. without beam deflection means) towards the machining point 5. At least one emitter 11a and/or at least one detector 11b may also be arranged on the chamfer 7 directed inwards.

The chamfer 7′ in FIG. 5b is directed outwards, i.e. away from the beam path of the laser beam 3 or the optical axis of the focusing optics 9. A mirror 116 may be provided to direct the beam path of the lidar sensor 11 arranged on the chamfer 7′ towards the machining point 5. The mirror 116 may be pivotable so as to adjust the detection space 111 of the lidar sensor 11. In this way, the machining area can be detected at different angles. At least one emitter 11a and/or at least one detector 11b may also be arranged on the chamfer 7′ directed outwards. As shown in FIG. 5b, a chamfer 7 directed inwards and a chamfer 7′ directed outwards may also be provided on the housing 2 and on the sensor holder 115, respectively, on which at least one lidar sensor 11 and at least one detector 11b or one emitter 11a are arranged, respectively.

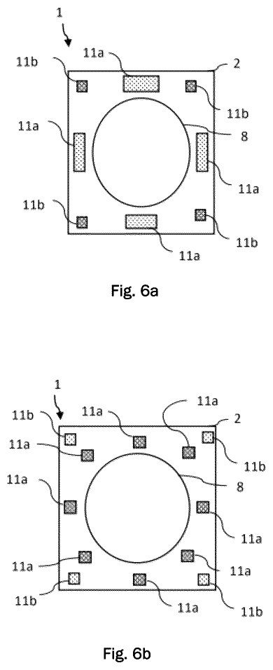

FIGS. 6a to 6d show emitters 11a and detectors 11b arranged in different numbers and different arrangements on a bottom side of the housing 2. The emitters 11a and detectors 11b may also be arranged on the module 50, as described for FIG. 2b, which is attached, for example, between the housing 2 and the nozzle 8 on the laser machining head 1. The emitters 11a and detectors 11b may also be mounted on the chamfer 7 or 7′ of the housing 2 or the sensor holder 115, as described in FIGS. 5a and 5b. Although the housing 2 is shown in this disclosure with a rectangular base shape, the housing may also have a round shape or any other shape in cross-section.

FIG. 6a shows a bottom side of the housing 2, on which a plurality of emitters 11a (here: four) and a plurality of detectors 11b (here: four) are arranged. The present disclosure is not limited to the specific number shown in the figure. The emitters 11a are each arranged at an equal distance from a center point of the bottom side or from the beam path of the laser beam 2 or from the optical axis of the focusing optics 9, with two emitters 11a lying opposite each other respectively. The detectors 11b are also each arranged at an equal distance from a center point or from the beam path of the laser beam 2 or from the optical axis of the focusing optics 9, with two detectors 11b lying opposite each other respectively. The emitters 11a and the detectors 11b are arranged alternately, i.e. a detector is arranged between two emitters 11a. When the housing 2 has a rectangular cross-section, the emitters 11a may be arranged in the center of the sides and the detectors 11b may be arranged in the corners. The detectors 11b may be at a greater distance from the beam path of the laser beam 3 than the emitters 11a.

FIG. 6b shows a bottom side of the housing 2, on which a plurality of emitters 11a (here:
eight) and a plurality of detectors 11b (here: four) are arranged. The present disclosure is not limited to the specific number shown in the figure. The emitters 11a are arranged along a circular line around a center point of the bottom side or around the beam path of the laser beam 2 or around the optical axis of the focusing optics 9. The detectors 11b are also each arranged at an equal distance from a center point or from the beam path of the laser beam 2 or from the optical axis of the focusing optics 9, with two detectors 11b lying opposite each other respectively. The detectors 11b may each be arranged at a corner of the housing 2. The detectors 11b may be at a greater distance from the beam path of the laser beam 3 than the emitters 11a.

FIG. 6c shows a bottom side of the housing 2, on which a plurality of emitters 11a (here: four) and a plurality of detectors 11b (here: four) are arranged. The present disclosure is not limited to the specific number shown in the figure. The emitters 11a and the detectors 11b are each arranged on a circular line around the beam path of the laser beam 3 and around the optical axis of the focusing optics 9, respectively. The circular line along which the emitters 11a are arranged may have a different radius (greater or smaller) than the circular line along which the detectors 11b are arranged. The emitters 11a and the detectors 11b may also be arranged on the same circular line.

FIG. 6d shows a bottom side of the housing 2, on which a plurality of emitters 11a (here: eight) and a detector 11b are arranged. The present disclosure is not limited to the specific number shown in the figure. The emitters 11a are arranged along a circular line around the beam path of the laser beam 3 or around the optical axis of the focusing optics 9. The detector 11b is formed along a side edge of the housing 2. For example, the detector 11b has a rectangular shape and is arranged symmetrically about a center of the side edge of the housing 2.
Depending on the type of process, the arrangement of a continuous-wave lidar sensor according to the invention may solve different problems. The information obtained by the sensor may be used to perform closed-loop control of the process parameters, in particular the feed rate, laser power, focus position of the laser beam, supply of any protective or fuel gases, or the angle of incidence of the laser beam.

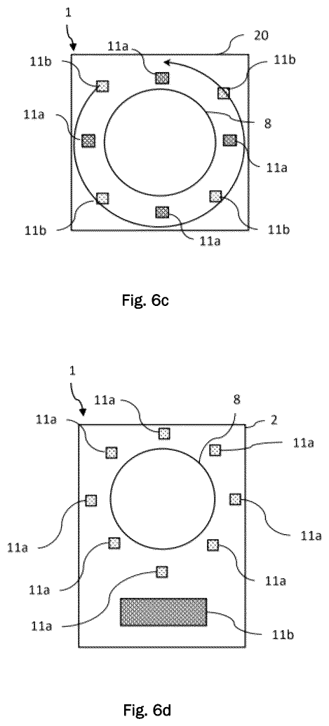

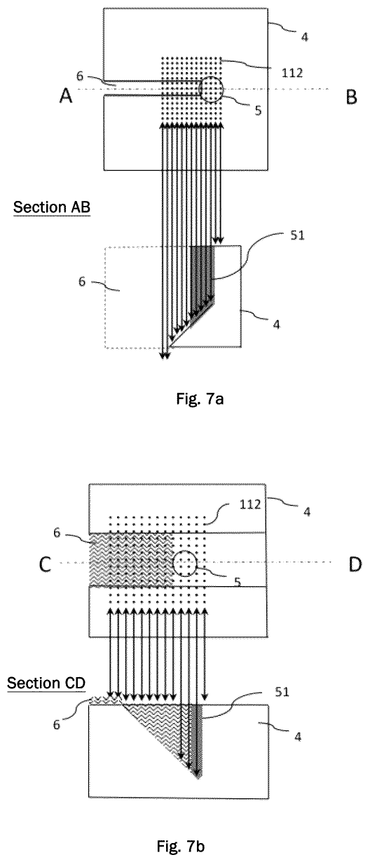

FIG. 7a shows a laser cutting process, i.e. the formation of a cutting kerf 6 in the workpiece 4. At the top, a view of the workpiece 4 and the machining point 5 is shown, at the bottom a sectional view along the axis AB. FIG. 7a shows a scanning grid 112 of at least one lidar sensor 11 and/or at least one detector 11b according to any of the arrangements described above. The individual measurement points of the scanning grid 112 (shown in dotted lines) may be equally and/or irregularly spaced.

In laser cutting, for example, the cutting front may be measured either at individual points or with a grid, so that any tearing of the cutting front can be prevented by performing closed-loop control of the aforementioned process parameters. The cutting front angle, inclination and length may be measured. In flame cutting, in particular, any cutting gap closure by the spatter in the wake may be detected. During fusion cutting, any spatter formation on the upper side of the sheet metal in the wake may be detected and registered for quality analysis. When piercing the workpiece, the piercing progress or the piercing depth may be measured. In this application, the exact distance does not necessarily have to be known; instead, only a minimum distance, which is given by the material thickness, may be known. When the measured value exceeds the specified minimum value, this may be interpreted as meaning that the piercing is complete. Furthermore, the intensity of the detected back reflection may also be measured to determine whether piercing has occurred.

FIG. 7b shows an operation during laser welding, i.e. the formation of a weld between two workpieces 4. At the top, a top view of the workpiece 4 and the machining point 5 is shown, at the bottom a sectional view along the axis CD. FIG. 7b shows a scanning grid 112 of at least one lidar sensor 11 and/or at least one detector 11b according to any of the arrangements described above. The individual measurement points of the scanning grid 112 (shown as dots) may be evenly spaced, but they may also be spaced irregularly.

In laser welding, the keyhole depth, topography, stability and/or fluctuation may be measured at one or more individual points or with a grid, thus allowing for an in-process quality assessment of the weld. Any deviation may lead to the closed-loop control of the process parameters and/or to a downstream repair. In addition, the seam position and/or geometry may be measured in advance (pre-process). In the wake (post-process), the seam or seam topography may be measured. For example, the geometry, periodic ripple, position, scaling of the weld seam, weld bead, weld pores, weld defects and/or weld cracks may be determined. The geometry of the deposited bead during laser deposition welding may also be measured in three dimensions.

In FIGS. 7a and 7b, a part of the scanning grid 112 is directed at the cutting kerf 6 in the workpiece 4 or at the weld seam 6 on the workpiece 4 (post-process area), a second part of the scanning raster 112 encompasses the machining point 5 and/or the cutting front 51 or the keyhole 51 (in-process area), and a third part of the scanning raster is directed to an area of the workpiece 4 that is not machined yet (pre-process area). Of course, the scanning grid 112 may also include only one or two of these areas. The lidar sensor or detector may be oriented such that the scanning grid 112 includes a TCP surrounding area with a predetermined radius around the machining point or TCP 5. For example, the radius may be 15 cm, 10 cm or 5 cm.

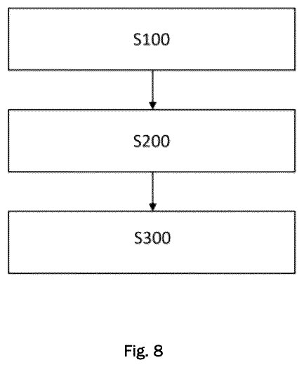

FIG. 8 is a flow chart for a method according to the present disclosure. The method may be carried out by the control 100 of the laser machining head 1 shown above. In step S100, the laser beam 3 is directed onto the workpiece by means of the laser machining head lin order to execute the machining process, e.g. laser cutting or welding. Before, during or after the execution of the machining process, a distance to at least one point on the workpiece is detected or measured by a continuous-wave lidar sensor 11 arranged on the laser machining head 1 in step S200. In step 300, the laser machining process is monitored and/or controlled based on this distance. The information obtained and the distances measured may be compared with existing data or certain target values and used for decision-making.

Monitoring the laser machining process may include determining a quality of the machining process, for example by measuring the machining result, i.e. the weld seam or the cutting joint, using the lidar sensor. Monitoring the laser machining process may also include determining the condition of parts of the laser machining head 1. For example, a measurement of the nozzle 8 may be used to draw conclusions about its state of wear or contamination. A degree of contamination of an optical component, such as a protective glass, may be determined by measuring the intensity of the back reflections detected by the lidar sensor 11.

Open-loop controlling and/or closed-loop controlling the laser machining process may include adjusting at least one process parameter based on the detected distance. The process parameter may, for example, be one of the following: machining speed, feed rate, laser power, focus position of the laser beam, position of the laser beam, angle of incidence of the laser beam on the workpiece, an angle of a scanner element for deflecting the laser beam, and pressure of a process gas. Open-loop controlling and/or closed-loop controlling the laser machining process may also include determining and/or adjusting a center position of the laser beam 3 with respect to the exit opening or nozzle 8.

The lidar sensor 11 may be used as a distance sensor system for the laser machining head 1 in order to determine a distance between the workpiece 4 and the laser machining head 1. The distance between the workpiece 4 and the laser machining head 1 may be used for open-loop and/or closed-loop control of the process. In one embodiment, this distance measurement may be used to precisely calibrate or replace a capacitive distance sensor system.

The method may further comprise determining workpiece parameters, such as any of the following: component geometry, cutting front position, cutting edge position, cutting front angle, cutting front length, cutting kerf width, keyhole depth, keyhole topography, keyhole stability, weld seam position, weld seam geometry, joint edge between two workpieces to be welded, cutting gap closure, spatter formation, diameter of a piercing hole, ejection height of a piercing hole, ejection diameter of a piercing hole, piercing depth and breakthrough. These parameters may in turn be taken into account in step S300 when monitoring and/or open-loop controlling and/or closed-loop controlling the machining process.

Due to the enormous versatility of the continuous-wave lidar sensor, a single and simple implementation of at least one sensor on a laser machining head may provide a wide range of process monitoring options, such as a three-dimensional measurement of the machining area.

### LIST OF REFERENCE SYMBOLS

1 Laser machining head
2 Housing
3 Laser beam
4 Workpiece
5 Machining point (TCP)
51 Keyhole
6 Cutting kerf and/or weld seam
7, 7′ Chamfer
8 Nozzle
9 Focusing optics
11 Lidar sensor
11a Emitter
11b Detector
111 Detection space
112 Scanning grid
113 Detection angle
114 Illumination space
115 Sensor holder
116 Mirror
20 Collimating optics
30 Fiber socket
50 Module
100 Controller
S100
S200
S300

1. A laser machining system for machining a workpiece by means of a laser beam, comprising:
a laser machining head comprising a housing in which at least one optical system for directing the laser beam onto a machining point on said workpiece is arranged, and at least one frequency-modulated and/or amplitude-modulated continuous-wave lidar sensor for detecting a distance to at least one point on said workpiece, said lidar sensor comprising an emitter and a detector; and
a control for monitoring and/or open-loop controlling and/or closed-loop controlling the machining process based on the detected distance.

2. The laser machining system according to claim 1, wherein said lidar sensor is configured to measure distances to a plurality of points on said workpiece within a TCP surrounding area having a radius of 20 cm around said machining point and/or within a machining area of said laser machining head.

3. The laser machining system according to claim 1, wherein said control is configured to adjust at least one process parameter based on the detected distance, wherein the at least one process parameter is selected from: machining speed, feed rate, laser power, laser power modulation, pulse-on time, pulse-off time, pulse peak power, focus position of the laser beam, position of the laser beam, magnification ratio, angle of incidence of the laser beam on the workpiece, angle of a scanner element for deflecting the laser beam, and pressure of a process gas.

4. The laser machining system according to claim 1, wherein an orientation of said detector and/or said emitter are adjustable.

5. The laser machining system according to claim 1, wherein a plurality of lidar sensors or a plurality of emitters and/or a plurality of detectors are arranged in a ring-like manner and/or rotatably around the beam path of said laser beam.

6. The laser machining system according to claim 1, wherein said emitter and/or said detector or said lidar sensor are arranged on a chamfered edge facing said machining point.

7. The laser machining system according to claim 1, claims, wherein said emitter and/or said detector or said lidar sensor are arranged on a chamfered edge of said housing facing away from said machining point, and a mirror arrangement is provided on said laser machining head in order to direct the respective beam path into the machining area of said laser machining head and/or into the TCP surrounding area.

8. The laser machining system according to claim 1, wherein said lidar sensor or said detector has a beam path that is coaxial with the beam path of said laser beam.

9. The laser machining system according to claim 8, wherein said lidar sensor or said detector is arranged at a laser beam entry port or at a fiber socket of said laser machining head for coupling into the laser beam.

10. The laser machining system according to claim 8, further comprising a beam splitter and/or a beam deflector for coupling a beam path of said lidar sensor or a beam path of said detector with the beam path of the laser beam.

11. The laser machining system according to claim 1, wherein said lidar sensor or said emitter is attached to said housing on the outside and/or a beam path of said lidar sensor or of said emitter extends completely outside of said housing.

12. The laser machining system according to claim 1, wherein said lidar sensor is attached to said housing so as to be pivotable and/or displaceable such that a position of said detection space and/or the center axis of said detection space and/or the optical axis of said lidar sensor are adjustable.

13. The laser machining system according to claim 1, wherein said laser machining head comprises a module which contains the at least one lidar sensor and is detachably attached to said housing or a sensor holder for fastening the at least one lidar sensor to said housing at a predetermined distance from said housing.

14. A method for performing a laser machining process, comprising the steps of:
directing a laser beam to a machining point on a workpiece for the laser machining process;
detecting a distance to at least one point on said workpiece by means of a frequency-modulated and/or amplitude-modulated continuous-wave lidar sensor; and
monitoring and/or open-loop controlling and/or closed-loop controlling the laser machining process based on the detected distance.

15. The method according to claim 14, further comprising:
determining, based on the detected distance, at least one of the following parameters: a component geometry, a position of a cutting front, a position of a cutting edge, a cutting kerf width, a cutting front angle, a cutting front length, a keyhole depth, a keyhole topography, a keyhole stability, a weld seam position, a weld seam geometry, a joining edge between two workpieces to be welded, a cutting gap closure, a spatter formation, a diameter of a piercing hole, an ejection height of a piercing hole, an ejection diameter of a piercing hole, a piercing depth and a breakthrough.
